(19) United States
(12) Patent Application Publication
(10) Pub. No.: US 2022/0320590 A1
(43) Pub. Date: Oct. 6, 2022

(54) SOLID STATE BATTERY

(71) Applicant: Murata Manufacturing Co., Ltd., Nagaokakyo-shi (JP)

(72) Inventors: Nobuyuki IWANE, Nagaokakyo-shi (JP); Noriyuki AOKI, Nagaokakyo-shi (JP); Katsunori TAKAHARA, Nagaokakyo-shi (JP); Yusuke FUNADA, Nagaokakyo-shi (JP); Kiyoshi KUMAGAE, Nagaokakyo-shi (JP); Keisuke SHIMIZU, Nagaokakyo-shi (JP)

(73) Assignee: Murata Manufacturing Co., Ltd., Nagaokakyo-shi (JP)

(21) Appl. No.: 17/848,859

(22) Filed: Jun. 24, 2022

Related U.S. Application Data
(63) Continuation of application No. PCT/JP2020/043822, filed on Nov. 25, 2020.

(30) Foreign Application Priority Data
Dec. 27, 2019 (JP) 2019-239047

(51) Int. Cl. H01M 10/0585; H01M 10/0525; H01M 4/485

(52) U.S. Cl. CPC H01M 10/0585; H01M 10/0525; H01M 4/485; H01M 2004/021

(57) ABSTRACT

A solid state battery including a positive electrode layer, a negative electrode layer, and a solid electrolyte layer interposed between the positive electrode layer and the negative electrode layer, wherein the positive electrode layer includes a positive electrode active material in which a spacing d₀₀₃ of a lattice plane (003) is 4.800 Å or more in a charged state at a positive electrode potential of 4.55 V.

### CROSS REFERENCE TO RELATED APPLICATIONS

The present application is a continuation of International application No. PCT/JP2020/043822, filed Nov. 25, 2020, which claims priority to Japanese Patent Application No. 2019-239047, filed Dec. 27, 2019, the entire contents of each of which are incorporated herein by reference.

### FIELD OF THE INVENTION

The present invention relates to a solid state battery. More specifically, the present invention relates to a stacked solid state battery formed by stacking layers constituting a battery constituent unit.

### BACKGROUND OF THE INVENTION

Conventionally, a secondary battery that can be repeatedly charged and discharged has been used for various applications. For example, secondary batteries are used as power sources of electronic devices such as smart phones and notebook computers.

In a secondary battery, a liquid electrolyte is generally used as a medium for ion transfer that contributes to charge and discharge. That is, a so-called electrolytic solution is used for the secondary battery. However, in such a secondary battery, safety is generally required from the viewpoint of preventing leakage of an electrolytic solution. Since an organic solvent or the like used for the electrolytic solution is a flammable substance, safety is required also in that respect.

Thus, a solid state battery using a solid electrolyte instead of an electrolytic solution has been studied (for example, Patent Document 1).

Patent Document 1: Japanese Patent Application Laid-Open No. 2017-011068

### SUMMARY OF THE INVENTION

The inventors of the present invention have found a new problem that when charge and discharge are repeated at a high charge voltage with a positive electrode potential of 4.4 V or more (for example, a positive electrode potential of 4.55 V) using a conventional solid state battery, crystallinity of a positive electrode active material contained in a positive electrode layer is reduced, and cycle characteristics are deteriorated.

An object of the present invention is to provide a solid state battery that more sufficiently prevents deterioration of cycle characteristics when charge and discharge are repeated at a high charge voltage with a positive electrode potential of 4.4 V or more (for example, a positive electrode potential of 4.55 V).

The present invention relates to a solid state battery including a positive electrode layer, a negative electrode layer, and a solid electrolyte layer interposed between the positive electrode layer and the negative electrode layer, wherein the positive electrode layer includes a positive electrode active material in which a spacing d₀₀₃ of a lattice plane (003) is 4.800 Å or more in a charged state at a positive electrode potential of 4.55 V. The positive electrode potential in the present specification means a relative potential (vs Li/Li+: standard electrode potential of Li alone is −3.045 V) with respect to a standard electrode potential of Li alone.

The solid state battery according to the present invention more sufficiently prevents deterioration of cycle characteristics when charge and discharge are repeated at a high charge voltage with a positive electrode potential of 4.4 V or more (for example, a positive electrode potential of 4.55 V).

### BRIEF EXPLANATION OF THE DRAWINGS

FIG. 1 is an external perspective view schematically showing a solid state battery according to an embodiment of the present invention.

FIG. 2 is a schematic sectional view of the solid state battery in FIG. 1 taken along line A-A as viewed in an arrow direction.

### DETAILED DESCRIPTION OF THE INVENTION

### Solid State Battery

Hereinafter, the “solid state battery” of the present invention will be described in detail. Although description will be made with reference to the drawings as necessary, illustrated contents are schematically and exemplarily shown wherein their appearances, their dimensional proportions and the like are not necessarily real ones, and are merely for the purpose of making it easy to understand the present invention.

The term “solid state battery” used in the present invention refers to, in a broad sense, a battery whose constituent elements are composed of solid and refers to, in a narrow sense, all solid state battery whose constituent elements (particularly preferably all constituent elements) are composed of solid. In a preferred embodiment, the solid state battery in the present invention is a stacked solid state battery configured such that layers constituting a battery constituent unit are stacked with each other, and preferably such layers are composed of a sintered body. The “solid state battery” includes not only a so-called “secondary battery” capable of repeating charging and discharging, but also a “primary battery” capable of only discharging. In a preferred embodiment of the present invention, the “solid state battery” is a secondary battery. The “secondary battery” is not excessively limited by its name, and can include, for example, electrochemical devices such as “a power storage device”.

The term “planar view” used here is based on a form where an object is viewed from above or below along a thickness direction based on a stacking direction of layers constituting the solid state battery, and includes a plan view (top view and bottom view). The term “sectional view” used here is based on a form when viewed from a direction substantially perpendicular to the thickness direction based on the stacking direction of layers constituting the solid state battery (to put it briefly, a form when taken along a plane parallel to the thickness direction), and includes a sectional view. In particular, the “sectional view” may be based on a form when taken along a plane parallel to the thickness direction based on the stacking direction of layers constituting the solid state battery and a plane passing through a positive electrode terminal and a negative electrode terminal. The terms “vertical direction” and “horizontal direction” directly or indirectly used here correspond respectively to the vertical direction and the horizontal direction in the drawing. Unless otherwise stated, the same numerals and symbols denote the same members or portions or the same contents. In a preferred embodiment, it can be grasped that a vertical downward direction (that is, a direction in which gravity acts) corresponds to a “downward direction”, and the opposite direction corresponds to an “upward direction”.

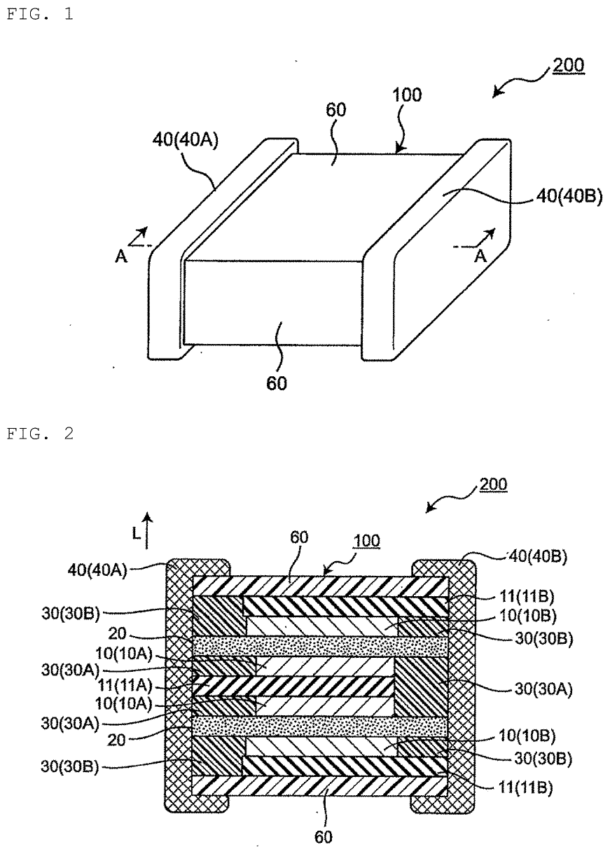

A solid state battery 200 according to the present invention includes, for example, a positive electrode layer 10A, a negative electrode layer 10B, and a solid electrolyte layer 20 interposed therebetween as shown in FIGS. 1 and 2. The solid state battery 200 according to the present invention usually includes: a solid state battery laminate 100 including at least one battery constituent unit, including the positive electrode layer 10A, the negative electrode layer 10B, and the solid electrolyte layer 20 interposed therebetween along a stacking direction L; a positive electrode terminal 40A and a negative electrode terminal 40B each provided on facing side surfaces of the solid state battery laminate 100. In the solid state battery laminate 100, the positive electrode layer 10A and the negative electrode layer 10B are alternately stacked with the solid electrolyte layer 20 interposed therebetween. FIG. 1 is an external perspective view schematically showing a solid state battery according to an embodiment of the present invention. FIG. 2 is a schematic sectional view of the solid state battery in FIG. 1 taken along line A-A as viewed in an arrow direction.

In the solid state battery, each layer constituting the solid state battery may be formed by firing, and the positive electrode layer 10A, the negative electrode layer 10B, the solid electrolyte layer 20, and the like form a sintered layer. Preferably, the positive electrode layer 10A, the negative electrode layer 10B, and the solid electrolyte layer 20 are fired integrally with each other, and therefore the battery constituent unit forms an integrally sintered body.

(Positive Electrode Layer)

The positive electrode layer 10A is an electrode layer containing at least a positive electrode active material. The positive electrode layer 10A may further include a solid electrolyte and/or a conductive material. In a preferred embodiment, the positive electrode layer is composed of a sintered body including at least the positive electrode active material and the solid electrolyte.

The positive electrode layer 10A includes a positive electrode active material (hereinafter, may be referred to as “positive electrode active material A”) in which a spacing d₀₀₃ of a lattice plane (003) is 4.800 Å or more in a charged state at a positive electrode potential of 4.55 V. In other words, the positive electrode layer 10A includes the positive electrode active material A in which a spacing d at an angle showing maximum intensity of a peak derived from 003 reflection in the charged state at a positive electrode potential of 4.55 V is 4.800 Å or more. The “charged state at a positive electrode potential of 4.55 V” refers to a state after constant current and constant voltage charge is performed at 0.2 C and a positive electrode potential of 4.55 V, and then a constant voltage of a positive electrode potential of 4.55 V is held until a charging current converges to 0.01 C. By using the positive electrode active material A having specific crystallinity as described above in such a charged state, deterioration of cycle characteristics is more sufficiently prevented when charge and discharge are repeated under a high charging voltage. Specifically, when Li is extracted from the positive electrode active material (when charge is performed), the spacing is initially increased due to repulsion between oxygen atoms. As the charge progresses, the spacing further increases and gradually reaches a limit point. The spacing of the limit point is generally 4.800 Å or more. As the charge further progresses, the spacing gradually starts to contract, and finally the phase transits to a high potential phase (H1-3 phase). The active material of the present invention has a characteristic that it hardly contracts when charged at a high potential. For example, when graphite is used for a negative electrode and charge is performed at a cell voltage of 4.5 V or more, the positive electrode does not start to contract, and a state in which the spacing is maintained at 4.800 Å can be maintained. Therefore, when the battery is cycled at a high potential, the number of times of expansion and contraction of the active material is reduced as compared with a conventional active material, a solid electrolyte interface and the positive electrode active material are held without being peeled off, and cracking of the active material is suppressed, so that the cycle characteristics are improved.

The upper limit value of the spacing d₀₀₃ of the lattice plane (003) of the positive electrode active material A in the charged state at a positive electrode potential of 4.55 V is not particularly limited, and the 003 spacing is usually 4.850 Å or less. The spacing d₀₀₃ of the lattice plane (003) of the positive electrode active material A in the charged state at a positive electrode potential of 4.55 V is preferably 4.800 Å to 4.830 Å, more preferably 4.800 Å to 4.810 Å, still more preferably 4.800 Å to 4.805 Å from the viewpoint of more sufficient prevention of peeling such as a contact interface between the positive electrode active material and the solid electrolyte based on more sufficient prevention of contraction of the positive electrode active material at a high potential.

From the viewpoint of achieving the 003 spacing d₀₀₃ in the charged state at a positive electrode potential of 4.55 V in the positive electrode active material A, the positive electrode active material A preferably satisfies predetermined particle diameter characteristics.

Specifically, the positive electrode active material A preferably has a moderately small average particle diameter and contains particles having a smaller particle diameter in a moderate amount. Since the positive electrode active material A has such particle diameter characteristics, contraction of the positive electrode active material at a high potential is more sufficiently prevented, and the 003 spacing d₀₀₃ in the charged state at a positive electrode potential of 4.55 V can be secured.

More specifically, D50 of the positive electrode active material A is preferably 4.5 μm or less (particularly 0.2 μm to 4.5 μm), more preferably 1.0 μm to 4.5 μm, still more preferably 1.5 μm to 3.0 μm, and most preferably 1.5 μm to 1.8 μm, from the viewpoint of more sufficient prevention of peeling such as the contact interface between the positive electrode active material and the solid electrolyte based on more sufficient prevention of contraction of the positive electrode active material at a high potential. When D50 of the positive electrode active material is too large, contraction of the positive electrode active material at a high potential cannot be sufficiently prevented, so that the spacing d₀₀₃ of the lattice plane (003) in the charged state at a positive electrode potential of 4.55 V decreases, and deterioration of the cycle characteristics cannot be sufficiently prevented.

D50 is a particle diameter (that is, an average particle diameter) at which frequency accumulation is 50%, and is also called a median diameter. As D50, D50 based on any 100 particles is used.

D10 of the positive electrode active material A is preferably 2.2 μm or less (particularly 0.1 μm to 2.2 μm), more preferably 0.5 μm to 2.2 μm, still more preferably 0.5 μm to 1.5 μm, and most preferably 0.5 μm to 0.5 μm, from the viewpoint of more sufficient prevention of peeling such as the contact interface between the positive electrode active material and the solid electrolyte based on more sufficient prevention of contraction of the positive electrode active material at a high potential. When D10 of the positive electrode active material is too large, contraction of the positive electrode active material at a high potential cannot be sufficiently prevented, so that the spacing d₀₀₃ of the lattice plane (003) in the charged state at a positive electrode potential of 4.55 V decreases, and deterioration of the cycle characteristics cannot be sufficiently prevented.

D10 is a particle diameter (that is, the average particle diameter) at which the frequency accumulation is 10%. As D10, D10 based on any 100 particles is used.

In the positive electrode active material A, particles having a relatively large particle diameter are preferably moderately reduced from the viewpoint of more sufficient prevention of peeling such as the contact interface between the positive electrode active material and the solid electrolyte based on more sufficient prevention of contraction of the positive electrode active material at a high potential. Therefore, D90/D50 of the positive electrode active material A is preferably 2.40 or less (particularly 1.10 to 2.40), more preferably 1.20 to 2.10, still more preferably 1.30 to 1.90, and most preferably 1.50 to 1.90.

D90 is a particle diameter (that is, the average particle diameter) at which the frequency accumulation is 90%. As D90, D90 based on any 100 particles is used.

The particle diameter (D10, D50 and D90) of the positive electrode active material A can be controlled by a known method. The particle diameter (D10, D50 and D90) of the positive electrode active material A can be controlled, for example, by adjusting synthesis conditions and/or pulverization conditions of the positive electrode active material A.

For example, at the time of synthesis of the positive electrode active material A by a solid phase method, the particle diameter of the positive electrode active material A can be controlled by adjusting mixing conditions and/or firing conditions of raw materials.

Specifically, the mixing conditions (for example, a rotation speed of a stirring blade and a stirring time) of the raw material used in the solid phase method are enhanced to further reduce the particle diameter of the raw material, whereby the particle diameter of the positive electrode active material A can be further reduced. On the other hand, the mixing conditions of the raw material used in the solid phase method are weaken to further increase the particle diameter of the raw material, whereby the particle diameter of the positive electrode active material A can be further increased.

Furthermore, the particle diameter of the positive electrode active material A can be further increased by further increasing a firing temperature in the solid phase method. On the other hand, the particle diameter of the positive electrode active material A can be further reduced by further lowering the firing temperature in the solid phase method.

D10, D50, D90, and D90/D50 of the positive electrode active material can be adjusted by, for example, removing small particles by air flow classification or removing large particles by sieving.

Specifically, D10, D50, and D90 can be further increased by removing some or all of small-diameter particles. At this time, increase widths of D10, D50, and D90 can be controlled by adjusting a removal amount of the small-diameter particles. For example, by further increasing the removal amount of the small-diameter particles, the increase width of D10 can be made larger than the increase widths of D50 and D90.

D10, D50, and D90 can be further reduced by removing some or all of large-diameter particles. At this time, reduction widths of D10, D50, and D90 can be controlled by adjusting the removal amount of the large-diameter particles. For example, by further increasing the removal amount of the large-diameter particles, the reduction width of D90 can be made larger than the reduction widths of D10 and D50.

D90/D50 can be further reduced by removing some or all of the small-diameter particles and/or some or all of the large-diameter particles (particularly, some or all of the large-diameter particles). At this time, the reduction width of D90/D50 can be controlled by adjusting the removal amount of the small-diameter particles and/or the large-diameter particles. For example, the reduction width of D90/D50 can be further increased by further increasing the removal amount of the small-diameter particles and/or the large-diameter particles.

The positive electrode active material A contained in the positive electrode layer 10A is a substance involved in transfer of electrons in the solid state battery. Ion movement (conduction) between the positive electrode layer and the negative electrode layer with the solid electrolyte interposed therebetween and electron transfer between the positive electrode layer and the negative electrode layer with an external circuit interposed therebetween are performed, so that charge and discharge are performed. The positive electrode layer is particularly preferably a layer capable of inserting and extracting a lithium ion. That is, the solid state battery of the present invention is preferably an all-solid-state secondary battery in which lithium ions move between the positive electrode layer and the negative electrode layer with the solid electrolyte interposed between the layers, thereby charging and discharging the battery.

A constituent material of the positive electrode active material A is a layered rock salt-type metal oxide, specifically, a lithium transition metal composite oxide. The fact that the positive electrode active material A is the layered rock salt-type metal oxide means that the metal oxide (particularly, particles thereof) has a layered rock salt-type crystal structure, and in a broad sense, it means that the metal oxide has a crystal structure that can be recognized as the layered rock salt-type crystal structure by a person skilled in the art of batteries. In a narrow sense, the fact that the positive electrode active material A is the layered rock salt-type metal oxide means that the metal oxide (particularly, particles thereof) is identified to have the layered rock salt-type crystal structure by analyzing an X-ray diffraction pattern by Rietveld analysis and the like. The lithium transition metal composite oxide is a generic term for oxides containing lithium and one or two or more kinds of transition metal elements as constituent elements.

The lithium transition metal composite oxide is, for example, a compound represented by each of LiₓM1_{y}O₂ and LiₓM1_{y}M2_{z}O₂. However, M1 is one kind or two or more kinds of transition metal elements. M2 includes aluminum, magnesium, boron, zinc, tin, calcium, strontium, bismuth, sodium, potassium, silicon, and phosphorus, and values of x, y, and z are arbitrary.

Specifically, the lithium transition metal composite oxide is, for example, LiCoO₂ (that is, lithium cobalt oxide), LiNiO₂, LiVO₂, LiCrO₂, LiCo_{1/3}Ni_{1/3}Mn_{1/3}O₂, or the like.

The positive electrode active material A is preferably a lithium transition metal composite oxide, particularly preferably lithium cobalt oxide from the viewpoint of more sufficient prevention of peeling such as the contact interface between the positive electrode active material and the solid electrolyte based on more sufficient prevention of contraction of the positive electrode active material at a high potential.

The content of the positive electrode active material A in the positive electrode layer 10A is usually 50% by mass or more (that is, 50% by mass to 100% by mass) with respect to a total amount of the positive electrode layer, and from the viewpoint of more sufficient prevention of peeling such as the contact interface between the positive electrode active material and the solid electrolyte based on more sufficient prevention of contraction of the positive electrode active material at a high potential, the content is preferably 60% by mass to 90% by mass, and more preferably 60% by mass to 80% by mass. The positive electrode layer may contain two or more types of positive electrode active materials A, and in that case, the total content thereof may be within the above range.

The positive electrode layer 10A may contain a positive electrode active material other than the positive electrode active material A. The content of the positive electrode active material other than the positive electrode active material A is usually 10% by mass or less with respect to the total amount of the positive electrode layer, and from the viewpoint of more sufficient prevention of peeling such as the contact interface between the positive electrode active material and the solid electrolyte based on more sufficient prevention of contraction of the positive electrode active material at a high potential, the content is preferably 5% by mass or less, and more preferably 0% by mass.

The solid electrolyte that may be contained in the positive electrode layer 10A may be selected from, for example, a material similar to the solid electrolyte that can be contained in the solid electrolyte layer described later. The positive electrode layer 10A may contain a glass ceramic-based solid electrolyte as a solid electrolyte.

The content of the solid electrolyte in the positive electrode layer 10A is not particularly limited, and is usually 10 to 40% by mass, and particularly 20 to 40% by mass with respect to the total amount of the positive electrode layer. The positive electrode layer may contain two or more types of positive electrode active materials, and in that case, the total content thereof may be within the above range.

The positive electrode layer 10A may further contain a sintering aid. Examples of the sintering aid include at least one selected from the group consisting of lithium oxide, sodium oxide, potassium oxide, boron oxide, silicon oxide, bismuth oxide, and phosphorus oxide.

The thickness of the positive electrode layer 10A is not particularly limited, and may be, for example, 2 μm to 100 μm, particularly 5 μm to 50 μm.

As shown in FIG. 2, the positive electrode layer 10A may have a positive electrode current collector layer 11A, or may not have the positive electrode current collector layer 11A. From the viewpoint of current collection efficiency of the positive electrode layer, the positive electrode layer preferably has the positive electrode current collector layer. When the positive electrode layer 10A has the positive electrode current collector layer 11A, the positive electrode layer 10A may be formed on both surfaces or one surface of the positive electrode current collector layer 11A as shown in FIG. 2. In this case, from the viewpoint of improving a battery capacity, the positive electrode layers 10A are preferably formed on both surfaces of the positive electrode current collector layer 11A as shown in FIG. 2.

The positive electrode current collector layer 11A is a coupling layer that achieves electrical connection between the positive electrode layer 10A and the positive electrode terminal 40A, and includes at least a conductive material. The positive electrode current collector layer 11A may further contain a solid electrolyte. In a preferred embodiment, the positive electrode current collector layer is composed of a sintered body including at least the conductive material and the solid electrolyte.

As the conductive material that may be contained in the positive electrode current collector layer 11A, a material having a relatively high conductivity is usually used, and for example, at least one selected from the group consisting of a carbon material, silver, palladium, gold, platinum, aluminum, copper, and nickel can be used.

The content of the conductive material in the positive electrode current collector layer 11A is usually 20% by mass or more (that is, 20 to 100% by mass), and particularly 30 to 90% by mass with respect to the total amount of the positive electrode current collector layer. The positive electrode current collector layer may contain two or more types of conductive materials, and in that case, the total content thereof may be within the above range.

The solid electrolyte that may be contained in the positive electrode current collector layer 11A may be selected from, for example, a material similar to the solid electrolyte that can be contained in the solid electrolyte layer described later. The positive electrode current collector layer 11A can contain a glass ceramic-based solid electrolyte as a solid electrolyte.

The content of the solid electrolyte in the positive electrode current collector layer 11A is not particularly limited, and is usually 10 to 80% by mass, and particularly 20 to 70% by mass with respect to the total amount of the positive electrode current collector layer. The positive electrode current collector layer may contain two or more types of positive electrode active materials, and in that case, the total content thereof may be within the above range.

When the positive electrode current collector layer has a form of a sintered body, the positive electrode current collector layer 11A may further contain a sintering aid. A sintering agent contained in the positive electrode current collector layer may be selected from, for example, a material similar to the sintering aid that can be contained in the positive electrode layer.

The thickness of the positive electrode current collector layer 11A is not particularly limited, and may be, for example, 2 μm to 100 μm, particularly 5 μm to 50 μm.

(Negative Electrode Layer)

The negative electrode layer 10B is an electrode layer containing at least a negative electrode active material. The negative electrode layer 10B may further contain a solid electrolyte. In a preferred embodiment, the negative electrode layer is composed of a sintered body including at least the negative electrode active material and the solid electrolyte.

The negative electrode active material contained in the negative electrode layer 10B is a substance involved in transfer of electrons in the solid state battery. Ion movement (conduction) between the positive electrode layer and the negative electrode layer with the solid electrolyte interposed therebetween and electron transfer between the positive electrode layer and the negative electrode layer with an external circuit interposed therebetween are performed, so that charge and discharge are performed. The negative electrode layer is particularly preferably a layer capable of inserting and extracting a lithium ion.

The negative electrode active material is, for example, a carbon material, a metal-based material, a lithium alloy, a lithium-containing compound, or the like.

Specifically, the carbon material is, for example, graphite, easily graphitizable carbon, non-graphitizable carbon, a mesocarbon microbead (MCMB), highly oriented graphite (HOPG), or the like.

The metal-based material is a generic term for a material containing one or two or more metal elements and metalloid elements capable of forming alloy with lithium as constituent elements. The metal-based material may be a simple substance, an alloy, a compound. Since purity of the simple substance described here is not necessarily limited to 100%, the simple substance may contain a trace amount of impurities.

Examples of the metal elements and the metalloid elements include silicon (Si), tin (Sn), aluminum (Al), indium (In), magnesium (Mg), boron (B), gallium (Ga), germanium (Ge), lead (Pb), bismuth (Bi), cadmium (Cd), titanium (Ti), chromium (Cr), iron (Fe), niobium (Nb), molybdenum (Mo), silver (Ag), zinc (Zn), hafnium (Hf), zirconium (Zr), yttrium (Y), palladium (Pd), and platinum (Pt) or the like.

Specifically, the metal-based material is, for example, Si, Sn, SiB₄, TiSi₂, SiC, Si₃N₄, SiOᵥ (0<v≤2), LiSiO, SnO_{w} (0<w≤2), SnSiO₃, LiSnO, Mg₂Sn, or the like.

The lithium-containing compound is, for example, a lithium transition metal composite oxide or the like. The definition regarding the lithium transition metal composite oxide is as described above. Specifically, examples of the lithium transition metal composite oxide include Li₃V₂(PO₄)₃, Li₃Fe₂(PO₄)₃, Li₄Ti₅O₁₂, LiTi₂(PO₄)₃, and LiCuPO₄.

The content of the negative electrode active material in the negative electrode layer 10B is usually 20% by mass or more (that is, 20 to 100% by mass), and particularly 30 to 90% by mass with respect to the total amount of the negative electrode layer. The negative electrode layer may contain two or more types of negative electrode active materials, and in that case, the total content thereof may be within the above range.

The solid electrolyte that may be contained in the negative electrode layer 10B may be selected from, for example, a material similar to the solid electrolyte that can be contained in the solid electrolyte layer described later. The negative electrode layer 10B can contain a glass ceramic-based solid electrolyte as a solid electrolyte.

The content of the solid electrolyte in the negative electrode layer 10B is not particularly limited, and is usually 10 to 80% by mass, and particularly 20 to 70% by mass with respect to the total amount of the negative electrode layer. The negative electrode layer may contain two or more types of positive electrode active materials, and in that case, the total content thereof may be within the above range.

The negative electrode layer 10B may further contain a sintering aid. Examples of the sintering aid include a material similar to the sintering aid that may be contained in the positive electrode layer 10A.

The thickness of the negative electrode layer 10B is not particularly limited, and may be, for example, 2 μm to 100 μm, particularly 5 μm to 50 μm.

As shown in FIG. 2, the negative electrode layer 10B may have a negative electrode current collector layer 11B, or may not have the negative electrode current collector layer 11B. From the viewpoint of the current collection efficiency of the negative electrode layer, the negative electrode layer can have the negative electrode current collector layer. When the negative electrode layer 10B has the negative electrode current collector layer 11B, the negative electrode layers 10B may be formed on both surfaces of the negative electrode current collector layer 11B, or may be formed on one surface as shown in FIG. 2.

The negative electrode current collector layer 11B is a coupling layer that achieves electrical connection between the negative electrode layer 10B and the negative electrode terminal 40B, and includes at least a conductive material. The negative electrode current collector layer 11B may further contain a solid electrolyte. In a preferred embodiment, the negative electrode current collector layer is composed of a sintered body including at least the conductive material and the solid electrolyte.

When the negative electrode layer 10B has the negative electrode current collector layer 11B, the negative electrode current collector layer 11B may be formed of the same constituent material as that of the positive electrode current collector layer 11A described above at the same ratio.

(Solid Electrolyte Layer)

The solid electrolyte layer 20 is a layer containing at least a solid electrolyte. In a preferred embodiment, the solid electrolyte layer is composed of a sintered body including at least the solid electrolyte.

The solid electrolyte constituting the solid electrolyte layer 20 is a material capable of conducting a lithium ion. In particular, the solid electrolyte forms a layer through which a lithium ion can conduct between the positive electrode layer and the negative electrode layer. The solid electrolyte may be provided at least between the positive electrode layer and the negative electrode layer. That is, the solid electrolyte may also exist around the positive electrode layer and/or the negative electrode layer so as to protrude from between the positive electrode layer and the negative electrode layer. The specific solid electrolyte includes, for example, one or two or more of a crystalline solid electrolyte, a glass-ceramic solid electrolyte, and the like. The solid electrolyte layer 20 may contain a glass ceramic-based solid electrolyte as a solid electrolyte.

The crystalline solid electrolyte is a crystalline electrolyte. Specifically, the crystalline solid electrolyte is, for example, an inorganic material, a polymer material, or the like, and the inorganic material is, for example, a sulfide, an oxide, or the like. The sulfide is, for example, Li₂S—P₂S₅, Li₂S—SiS₂—Li₃PO₄, Li₇P₃S₁₁, Li_{3.25}Ge_{0.25}P_{0.75}S, Li₁₀GeP₂S₁₂, or the like. Examples of the oxide include LiₓM_{y}(PO₄)₃ (1≤x≤2, 1≤y≤2, and M is at least one selected from the group consisting of Ti, Ge, Al, Ga, and Zr), Li₇La₃Zr₂O₁₂, Li_{6.75}La₃Zr_{1.75}Nb_{0.25}O₁₂, Li₆BaLa₂Ta₂O₁₂, Li₁₊ₓAlₓTi₂₋ₓ (PO₄)₃, La_{2/3}—ₓLi₃ₓTiO₃, Li_{1.2}Al_{0.2}Ti_{1.8}(PO₄)₃, La_{0.55}Li_{0.35}TiO₃, and Li₇La₃Zr₂O₁₂ and the like. The polymer material is, for example, polyethylene oxide (PEO) or the like.

The glass-ceramic solid electrolyte is an electrolyte in which amorphous and crystal are mixed. The glass-ceramic solid electrolyte is, for example, an oxide containing lithium (Li), silicon (Si), and boron (B) as constituent elements, and more specifically contains lithium oxide (Li₂O), silicon oxide (SiO₂), boron oxide (B₂O₃), and the like. The proportion of the content of lithium oxide to the total content of lithium oxide, silicon oxide, and boron oxide is not particularly limited, and is, for example, 40 mol % to 73 mol %. The proportion of the content of silicon oxide to the total content of lithium oxide, silicon oxide, and boron oxide is not particularly limited, and is, for example, 8 mol % to 40 mol %. The proportion of the content of boron oxide to the total content of lithium oxide, silicon oxide, and boron oxide is not particularly limited, and is, for example, 10 mol % to 50 mol %. In order to measure the respective contents of lithium oxide, silicon oxide and boron oxide, the glass-ceramic solid electrolyte is analyzed by using, for example, inductively coupled plasma emission spectroscopy (ICP-AES).

The solid electrolyte layer 20 may further contain a sintering aid. Examples of the sintering aid include a material similar to the sintering aid that may be contained in the positive electrode layer 10A.

The thickness of the solid electrolyte layer is not particularly limited, and may be, for example, 1 μm to 15 μm, particularly 1 μm to 5 μm.

(Electrode Separator)

The solid state battery 200 of the present invention usually further includes an electrode separator (also referred to as “margin layer” or “margin portion”) 30 (30A, 30B).

The electrode separator 30A (positive electrode separator) is disposed around the positive electrode layer 10A, so that the positive electrode layer 10A is spaced apart from the negative electrode terminal 40B. The electrode separator 30B (negative electrode separator) is disposed around the negative electrode layer 10B, so that the negative electrode layer 10B is spaced apart from the positive electrode terminal 40A. Although not particularly limited, the electrode separator 30 may be compose of, for example, one or more materials selected from the group consisting of a solid electrolyte, an insulating material, a mixture thereof, and the like.

As the solid electrolyte that can constitute the electrode separator 30, the same material as the solid electrolyte that can constitute the solid electrolyte layer can be used.

The insulating material that can constitute the electrode separator 30 may be a material that does not conduct electricity, that is, a non-conductive material. Although not particularly limited, the insulating material may be, for example, a glass material, a ceramic material, or the like. For example, a glass material may be selected as the insulating material. Although not particularly limited, examples of the glass material include at least one selected from the group consisting of soda lime glass, potash glass, borate glass, borosilicate glass, barium borosilicate-based glass, zinc borate glass, barium borate glass, borosilicate bismuth salt-based glass, bismuth zinc borate glass, bismuth silicate glass, phosphate glass, aluminophosphate glass, and zinc phosphate glass. Although not particularly limited, examples of the ceramic material include at least one selected from the group consisting of aluminum oxide (Al₂O₃), boron nitride (BN), silicon dioxide (SiO₂), silicon nitride (Si₃N₄), zirconium oxide (ZrO₂), aluminum nitride (AlN), silicon carbide (SiC), and barium titanate (BaTiO₃).

(Terminal)

The solid state battery 200 of the present invention is generally provided with a terminal (external terminal) 40 (40A, 40B). In particular, terminals 40A and 40B of the positive and negative electrodes are provided to form a pair on a side surface of the solid state battery. More specifically, the terminal 40A on the positive electrode side connected to the positive electrode layer 10A and the terminal 40B on the negative electrode side connected to the negative electrode layer 10B are provided so as to form a pair. As the terminal 40 (40A, 40B) as described above, it is possible to use a material having high conductivity. Although not particularly limited, examples of the material of the terminal 40 include at least one conductive material selected from the group consisting of silver, gold, platinum, aluminum, copper, tin, and nickel.

The terminal 40 (40A, 40B) may further contain a sintering aid. Examples of the sintering aid include a material similar to the sintering aid that may be contained in the positive electrode layer 10A.

In a preferred embodiment, the terminal 40 (40A, 40B) is composed of a sintered body including at least the conductive material and the sintering aid.

(Outer Layer Material)

The solid state battery 200 of the present invention usually further includes an outer layer material 60.

The outer layer material 60 can be generally formed on an outermost side of the solid state battery, and used to electrically, physically, and/or chemically protect. As a material forming the outer layer material 60, preferred is a material that is excellent in insulation property, durability and/or moisture resistance, and is environmentally safe. For example, it is possible to use glass, ceramics, a thermosetting resin, a photocurable resin, a mixture thereof, and the like.

As glass that can constitute the outer layer material, the same material as the glass material that can constitute the electrode separator can be used.

As a ceramic material that can constitute the outer layer material, the same material as the ceramic material that can constitute the electrode separator can be used.

### Method of Manufacturing Solid State Battery

The solid state battery of the present invention can be manufactured by a printing method such as a screen printing method, a green sheet method using a green sheet, or a method combining these methods. Hereinafter, a case where the printing method and the green sheet method are adopted for understanding the present invention will be described in detail, but the present invention is not limited to these methods.

### Step of Forming Solid State Battery Laminate Precursor

In the present step, for example, several types of pastes such as a positive electrode layer paste, a negative electrode layer paste, a solid electrolyte layer paste, a positive electrode current collector layer paste, a negative electrode current collector layer paste, an electrode separator paste, and an outer layer material paste are used as ink. That is, a solid state battery laminate precursor having a predetermined structure is formed on a supporting substrate by applying and drying the paste by the printing method.

In the printing, printing layers are sequentially stacked with a predetermined thickness and a predetermined pattern shape, whereby a solid state battery laminate precursor corresponding to a structure of a predetermined solid state battery can be formed on the substrate. The kind of the pattern forming method is not particularly limited as long as the pattern forming method is a method capable of forming a predetermined pattern, and, for example, one or two or more of a screen printing method, a gravure printing method, and the like may be used.

The paste can be prepared by wet mixing a predetermined constituent material of each layer appropriately selected from the group consisting of positive electrode active material particles, negative electrode active material particles, the solid electrolyte material, a current collector layer material, the insulating material, the sintering aid, and other materials described above with an organic vehicle in which an organic material is dissolved in a solvent.

The positive electrode layer paste contains, for example, the positive electrode active material particles, the solid electrolyte material, an organic material, a solvent, and optionally a sintering aid.

The negative electrode layer paste contains, for example, the negative electrode active material particles, the solid electrolyte material, an organic material, a solvent, and optionally a sintering aid.

The solid electrolyte layer paste contains, for example, the solid electrolyte material, an organic material, a solvent, and optionally a sintering aid.

The positive electrode current collector layer paste contains a conductive material, an organic material, a solvent, and optionally a sintering aid.

The negative electrode current collector layer paste contains a conductive material, an organic material, a solvent, and optionally a sintering aid.

The electrode separator paste contains, for example, the solid electrolyte material, an insulating material, an organic material, a solvent, and optionally a sintering aid.

The outer layer material paste contains, for example, an insulating material, an organic material, a solvent, and optionally a sintering aid.

The organic material contained in the paste is not particularly limited, and it is possible to use at least one polymer material selected from the group consisting of a polyvinyl acetal resin, a cellulose resin, a polyacrylic resin, a polyurethane resin, a polyvinyl acetate resin, a polyvinyl alcohol resin, and the like.

The type of the solvent is not particularly limited, and the solvent is, for example, one or two or more organic solvents such as butyl acetate, N-methyl-pyrrolidone, toluene, terpineol, and N-methyl-pyrrolidone.

In the wet mixing, a medium can be used, and specifically, a ball mill method, a visco mill method, or the like can be used. On the other hand, wet mixing methods may be used which use no media, and a sand mill method, a high-pressure homogenizer method, a kneader dispersion method, or another method can be used.

The supporting substrate is not particularly limited as long as the supporting substrate is a support capable of supporting each paste layer, and the supporting substrate is, for example, a release film having one surface subjected to a release treatment, or the like. Specifically, a substrate formed from a polymer material such as polyethylene terephthalate can be used. When the paste layer is used in the firing step while being held on the substrate, the substrate having heat resistance to firing temperature may be used.

Alternatively, each green sheet may be formed from each paste, and the obtained green sheets may be stacked to prepare a solid state battery laminate precursor.

Specifically, the supporting substrate applied with each paste is dried on a hot plate heated to 30° C. or higher and 90° C. or lower to form, on each supporting substrate (for example, a PET film), a positive electrode layer green sheet, a negative electrode layer green sheet, a solid electrolyte layer green sheet, a positive electrode current collector layer green sheet, a negative electrode current collector layer green sheet, an electrode separator green sheet and/or an outer layer material green sheet or the like having a predetermined shape and thickness.

Next, each green sheet is peeled off from the substrate. After the peeling, the green sheets of the constituent elements are sequentially stacked along the stacking direction to form a solid state battery laminate precursor. After the stacking, a solid electrolyte layer, an insulating layer and/or a protective layer may be provided in a side region of an electrode green sheet by screen printing.

(Firing Step)

In the firing step, the solid state battery laminate precursor is subjected to firing. Although the followings are merely examples, firing is carried out by removing the organic material by heating in a nitrogen gas atmosphere containing oxygen gas or in the atmosphere, for example, at 200° C. or higher, and then heating in the nitrogen gas atmosphere or in the atmosphere, for example, at 300° C. or higher. Firing may be carried out while pressurizing the solid state battery laminate precursor in the stacking direction (in some cases, stacking direction and direction perpendicular to the stacking direction).

By undergoing such firing, a solid state battery laminate is formed, so that a desired solid state battery is finally obtained.

(Step of Forming Positive Electrode Terminal and Negative Electrode Terminal)

For example, the positive electrode terminal is bonded to the solid state battery laminate using a conductive adhesive, and the negative electrode terminal is bonded to the solid state battery laminate using a conductive adhesive. Consequently, each of the positive electrode terminal and the negative electrode terminal is attached to the solid state battery laminate, so that the solid state battery is completed.

Although the embodiments of the present invention have been described above, those are merely typical examples. Therefore, the present invention is not limited to those embodiments, and those skilled in the art will readily understand that various aspects can be conceived without changing the gist of the present invention.

### EXAMPLES

### Example 1

(Process of Producing Solid Electrolyte Layer-Producing Green Sheet)

First, lithium-containing oxide glass as a solid electrolyte and an acrylic binder were mixed in a mass ratio of lithium-containing oxide glass:acrylic binder=70:30. As the lithium-containing oxide glass, one having a composition of Li2O:SiO2:B203=60:10:30 (mol % ratio) was used. Next, the resulting mixture was mixed with butyl acetate so that the solid content was 30% by mass, and then this mixture was stirred with zirconia balls having a diameter of 5 mm for 4 hours to obtain a solid electrolyte layer-producing paste. Subsequently, this paste was applied onto a release film and dried at 80° C. for 10 minutes to produce a solid electrolyte layer-producing green sheet as a solid electrolyte layer precursor.

(Preparation of Positive Electrode Active Material Layer-Producing Green Sheet)

First, lithium cobalt oxide (LiCoO2) was synthesized by a solid phase method in which cobalt oxide and lithium carbonate were mixed and fired. The mixing conditions and the firing temperature were controlled, coarse particles (large-diameter particles) were removed by sieving, and small-diameter particles were classified to obtain lithium cobalt oxide having a D50 particle diameter, a D10 particle diameter, a D90 particle diameter, a particle diameter distribution (D90/D50), and a 003 spacing as shown in Table 1.

Next, lithium cobalt oxide (LiCoO2) as a positive electrode active material and the lithium-containing oxide glass as a solid electrolyte were mixed in a mass ratio of lithium cobalt oxide:lithium-containing oxide glass=70:30. As the lithium-containing oxide glass, one having a composition of Li2O:SiO2:B203=60:10:30 (mol % ratio) was used. Next, the resulting mixture and an acrylic binder were mixed in a mass ratio of mixture (lithium cobalt oxide+lithium-containing oxide glass):acrylic binder=70:30, and then this mixture was mixed with butyl acetate so that the solid content was 30% by mass. Then, the resulting mixture was stirred with zirconia balls having a diameter of 5 mm for 4 hours to obtain a positive electrode active material layer-producing paste. Subsequently, this paste was applied onto a release film and dried at 80° C. for 10 minutes to produce a positive electrode active material layer-producing green sheet as a positive electrode layer precursor.

(Process of Producing Negative Electrode Active Material Layer-Producing Green Sheet)

First, a carbon powder (KS 6 manufactured by TIMCAL Ltd.) as a negative electrode active material and a lithium-containing oxide glass as a solid electrolyte were mixed in a mass ratio of carbon powder:lithium-containing oxide glass=70:30. As the lithium-containing oxide glass, one having a composition of Li2O:SiO2:B203=60:10:30 (mol % ratio) was used. Next, the resulting mixture and an acrylic binder were mixed in a mass ratio of mixture (carbon powder+lithium-containing oxide glass):acrylic binder=70:30, and then this mixture was mixed with butyl acetate so that the solid content was 30% by mass. Then, the resulting mixture was stirred with zirconia balls having a diameter of 5 mm for 4 hours to obtain a negative electrode active material layer-producing paste. Subsequently, this paste was applied onto a release film and dried at 80° C. for 10 minutes to produce a negative electrode active material layer-producing green sheet as a negative electrode active material layer precursor.

(Process of Producing Green Sheet for Producing Positive Electrode Current Collector Layer)

First, a carbon powder (KS 6 manufactured by TIMCAL Ltd.) as a conductive material and a lithium-containing oxide glass as a solid electrolyte were mixed in a mass ratio of carbon powder:lithium-containing oxide glass=70:30. As the lithium-containing oxide glass, one having a composition of Li2O:SiO2:B203=60:10:30 (mol % ratio) was used. Next, the resulting mixture and an acrylic binder were mixed in a mass ratio of mixture (carbon powder+lithium-containing oxide glass):acrylic binder=70:30, and then this mixture was mixed with butyl acetate so that the solid content was 30% by mass. Then, the resulting mixture was stirred with zirconia balls having a diameter of 5 mm for 4 hours to obtain a positive electrode current collector layer-producing paste. Subsequently, this paste was applied onto a release film and dried at 80° C. for 10 minutes to produce an intermediate layer-producing green sheet as an intermediate layer precursor.

(Process of Producing Green Sheet for Producing Negative Electrode Current Collector Layer)

A green sheet for producing a negative electrode current collector layer was produced in the same manner as in “Process of producing green sheet for producing positive electrode current collector layer” described above.

(Process of Producing Outer Layer Material-Producing Green Sheet)

First, an alumina particle powder (AHP 300 manufactured by Nippon Light Metal Company, Ltd.) as a particle powder and lithium-containing oxide glass (B) as a solid electrolyte were mixed in a mass ratio of alumina particle powder:lithium-containing oxide glass (B)=50:50. Next, the resulting mixture and an acrylic binder were mixed in a mass ratio of mixture (alumina particle powder+lithium-containing oxide glass (B)):acrylic binder=70:30, and then this mixture was mixed with butyl acetate so that the solid content was 30% by mass. Then, the resulting mixture was stirred with zirconia balls having a diameter of 5 mm for 4 hours to obtain a paste for producing a principal surface exterior material. Subsequently, this paste was applied onto a release film and dried to produce an outer layer material-producing green sheet as a principal surface outer layer material precursor.

(Process of Producing Electrode Separator-Producing Green Sheet)

An electrode separator-producing green sheet as an electrode separator precursor was produced in the same manner as in “Process of producing outer layer material-producing green sheet” described above.

(Process of Preparing Laminate)

Using each green sheet obtained as described above, a laminate having the configuration shown in FIGS. 1 and 2 was prepared as follows. First, each green sheet was processed into the shape shown in FIGS. 1 and 2, and then released from the release film. Subsequently, the green sheets were sequentially stacked so as to correspond to a configuration of a battery element shown in FIGS. 1 and 2, and then thermocompression-bonded. As a result, a laminate as a battery element precursor was obtained.

(Process of Sintering Laminate)

The obtained laminate was heated to remove the acrylic binder contained in each green sheet, and then further heated to sinter the oxide glass contained in each green sheet.

(Process of Producing Terminal)

First, an Ag powder (Daiken Chemical Co., Ltd.) as a conductive particle powder and oxide glass (Bi—B based glass, ASF1096 manufactured by Asahi Glass Co., Ltd.) were mixed at a predetermined mass ratio. Next, the resulting mixture and an acrylic binder were mixed in a mass ratio of mixture (Ag powder+oxide glass):acrylic binder=70:30, and then this mixture was mixed with a butyl acetate solvent so that the solid content was 50% by mass. Then, the resulting mixture was stirred with zirconia balls having a diameter of 5 mm for 4 hours to obtain a conductive paste. Next, after this conductive paste was applied onto the release film, the conductive paste was attached to first and second end surfaces (or side surfaces) of the laminate in which the positive electrode current collector layer and the negative electrode current collector layer were exposed, respectively, and sintered to form positive and negative electrode terminals. Thus, a target battery was obtained.

(Measurement of Cycle Characteristics)

A rated capacity of the battery is set to 1 C, the battery is charged to a positive electrode potential of 4.55 V at a constant current of 0.2 C, and after the positive electrode potential reaches 4.55 V, the battery is charged in a constant voltage mode until the current is contracted to 0.01 C. Thereafter, discharge is performed at a constant current of 0.2 C until the positive electrode potential reaches 3 V. A capacity retention rate with respect to an initial discharge capacity when 100 cycles were repeated with such charge and discharge as 1 cycle was measured.

The capacity retention rate was evaluated according to the following criteria:

⊙⊙: 90%≤ratio (extra best);

⊙: 87%≤ratio<90% (best);

○: 84%≤ratio<87% (good);

Δ: 80%≤ratio<84% (acceptable (no problem in practical use));

×: ratio<80% (problem in practical use).

(X-ray Diffraction Measurement)

The battery is charged at a current value of 0.2 C, and after the positive electrode potential reaches 4.55 V, constant current and constant voltage charge is performed in which charge is performed until the current is contracted to 0.01 C. After 1 hour or more has elapsed from completion of charge, the 003 spacing of the positive electrode active material is measured by an X-ray diffraction measuring device (D8 Advance manufactured by Bruker). A step width is desirably 0.01° or less, and a count time is desirably 0.3 seconds or more.

Specifically, the positive electrode layer is exposed by polishing or disassembling. After confirming by voltage measurement with a tester that no short circuit due to work has occurred, XRD measurement is performed as described above. When there is a concern about material alteration due to atmospheric exposure, a series of operations and measurements are performed under an inert atmosphere.

Among peaks caused by 003 in an XRD spectrum of the positive electrode active material obtained as described above, the spacing at the angle showing the maximum intensity is calculated, and defined as the spacing.

(Method of Measuring Particle Diameter)

A cross section of the positive electrode layer is observed with an optical microscope or an electron microscope, lengths of cross sections of 100 randomly selected particles are measured, and D50 (median diameter), D10, and D90 are calculated. A line is drawn from end to end of the cross section, and a distance between two points having a maximum length is defined as the particle diameter.

(Method of Measuring Positive Electrode Potential)

Examples of the method of measuring the positive electrode potential include, but are not limited to, a method in which an exterior of the battery is peeled off, metal Li is pressure-bonded as a reference electrode to a solid state electrolyte exposed portion, sealing is performed again using an aluminum laminate film or the like to form a three-electrode cell, and the voltage between an Li electrode and the positive electrode is set to the positive electrode potential.

### Examples 2 to 5 and Comparative Examples 1 to 3

The solid state battery was produced and evaluated by the same method as in Example 1 except that in the step of producing a positive electrode active material layer-producing green sheet, the mixing conditions of cobalt oxide and lithium carbonate and the firing temperature were controlled, coarse particles (large-diameter particles) were removed by sieving, and small-diameter particles were classified to obtain lithium cobalt oxide having a predetermined D50 particle diameter, D10 particle diameter, D90 particle diameter, particle diameter distribution (D90/D50), and 003 spacing as shown in Table 1.

TABLE 1

| | | | | | | Capacity |
|---|---|---|---|---|---|---|
| | | | | | Particle | retention |
| | | | | | diameter | rate after |
| | Spacing | D10 | D50 | D90 | distribution | 100 cycles |
| | (Å) | (μm) | (μm) | (μm) | D90/D50 | (%) |
| Example 1 | 4.801 | 0.2 | 0.3 | 0.7 | 2.33 | Δ83% |
| Example 2 | 4.801 | 0.9 | 1.7 | 3 | 1.76 | ⊙⊙91% |
| Example 3 | 4.807 | 1.2 | 2 | 2.8 | 1.40 | ⊙88% |
| Example 4 | 4.807 | 1.7 | 3.7 | 5.2 | 1.41 | ◯85% |
| Example 5 | 4.812 | 2 | 4 | 8.1 | 2.02 | ◯85% |
| Comparative | 4.739 | 3 | 4.7 | 7.2 | 1.53 | X70% |
| Example 1 | | | | | | |
| Comparative | 4.793 | 2.3 | 3.9 | 6.1 | 1.56 | X73% |
| Example 2 | | | | | | |
| Comparative | 4.729 | 3.2 | 5.8 | 10.1 | 1.74 | X55% |
| Example 3 | | | | | | |

The solid state battery of the present invention can be used in various fields in which electricity storage is assumed. Although the followings are merely examples, the solid state battery of the present invention can be used in electricity, information and communication fields where mobile equipment and the like are used (e.g., electrical/electronic equipment fields or mobile device fields including mobile phones, smart phones, laptop computers, digital cameras, activity meters, arm computers, electronic papers, and small electronic devices such as RFID tags, card type electronic money, and smartwatches), domestic and small industrial applications (e.g., the fields such as electric tools, golf carts, domestic robots, caregiving robots, and industrial robots), large industrial applications (e.g., the fields such as forklifts, elevators, and harbor cranes), transportation system fields (e.g., the fields such as hybrid vehicles, electric vehicles, buses, trains, electric assisted bicycles, and two-wheeled electric vehicles), electric power system applications (e.g., the fields such as various power generation systems, load conditioners, smart grids, and home-installation type power storage systems), medical applications (medical equipment fields such as earphone hearing aids), pharmaceutical applications (the fields such as dose management systems), IoT fields, and space and deep sea applications (e.g., the fields such as spacecraft and research submarines).

### DESCRIPTION OF REFERENCE SYMBOLS

10: Electrode layer
10A: Positive electrode layer
10B: Negative electrode layer
11: Electrode current collector layer
11A: Positive electrode current collector layer
11B: Negative electrode current collector layer
20: Solid electrolyte layer
30: Positive electrode separator
30A: Positive electrode separator
30B: Negative electrode separator
40: Terminal
40A: Positive electrode terminal
40B: Negative electrode terminal
60: Outer layer material
100: Solid state battery laminate
200: Solid state battery

1. A solid state battery comprising:
a positive electrode layer;
a negative electrode layer; and
a solid electrolyte layer interposed between the positive electrode layer and the negative electrode layer,
wherein the positive electrode layer includes a positive electrode active material in which a spacing d₀₀₃ of a lattice plane (003) is 4.800 Å or more in a charged state at a positive electrode potential of 4.55 V.

2. The solid state battery according to claim 1, wherein the spacing d₀₀₃ of the lattice plane (003) is 4.800 Å to 4.830 Å in the charged state at the positive electrode potential of 4.55 V.

3. The solid state battery according to claim 1, wherein the spacing d₀₀₃ of the lattice plane (003) is 4.800 Å to 4.810 Å in the charged state at the positive electrode potential of 4.55 V.

4. The solid state battery according to claim 1, wherein the spacing d₀₀₃ of the lattice plane (003) is 4.800 Å to 4.805 Å in the charged state at the positive electrode potential of 4.55 V.

5. The solid state battery according to claim 1, wherein the positive electrode active material has a median diameter D50 of 0.2 μm to 4.5 μm.

6. The solid state battery according to claim 5, wherein the positive electrode active material has an average particle diameter D10 of 0.1 μm to 2.2 μm.

7. The solid state battery according to claim 1, wherein the positive electrode active material has a median diameter D50 of 1.0 μm to 4.5 μm.

8. The solid state battery according to claim 7, wherein the positive electrode active material has an average particle diameter D10 of 0.5 μm to 2.2 μm.

9. The solid state battery according to claim 1, wherein the positive electrode active material has a median diameter D50 of 1.5 μm to 3.0 μm.

10. The solid state battery according to claim 9, wherein the positive electrode active material has an average particle diameter D10 of 0.5 μm to 1.5 μm.

11. The solid state battery according to claim 1, wherein the positive electrode active material has a median diameter D50 of 1.5 μm to 1.8 μm.

12. The solid state battery according to claim 11, wherein the positive electrode active material has an average particle diameter D10 of 0.5 μm to 0.5 μm.

13. The solid state battery according to claim 1, wherein a ratio D90/D50 of particle diameters of the positive electrode active material is 2.4 or less.

14. The solid state battery according to claim 1, wherein a ratio D90/D50 of particle diameters of the positive electrode active material is 1.1 to 2.4.

15. The solid state battery according to claim 1, wherein the positive electrode layer contains the positive electrode active material and a solid electrolyte, and
a content of the positive electrode active material is 60 to 90% by mass with respect to a total amount of the positive electrode layer.

16. The solid state battery according to claim 1, wherein the positive electrode active material is a lithium transition metal composite oxide.

17. The solid state battery according to claim 16, wherein the lithium transition metal composite oxide is lithium cobalt oxide.

18. The solid state battery according to claim 1, wherein the positive electrode layer and the negative electrode layer are layers capable of inserting and extracting a lithium ion.
